(19) United States
(12) Patent Application Publication
(10) Pub. No.: US 2019/0160721 A1
(43) Pub. Date: May 30, 2019

(54) HALF NUT OPENING/CLOSING DEVICE

(71) Applicant: U-MHI PLATECH CO., LTD., Nagoya-shi (JP)

(72) Inventors: Hiroaki KYUNO, Tokyo (JP); Kazunori KUGA, Tokyo (JP); Isao HASHIMOTO, Tokyo (JP); Toshihiko KARIYA, Nagoya-shi, Aichi (JP); Naoki KATO, Nagoya-shi, Aichi (JP)

(21) Appl. No.: 16/313,107

(22) PCT Filed: Sep. 26, 2017
(86) PCT No.: PCT/JP2017/034724

§ 371 Date: Dec. 24, 2018

(30) Foreign Application Priority Data
Dec. 21, 2016 (JP) 2016-247734

(51) Int. Cl. B29C 45/64; B29C 33/24

(52) U.S. Cl. CPC B29C 45/641; B29C 45/67; B29C 2045/642; B29C 33/24

(57) ABSTRACT

Provided is a half nut opening/closing device that makes it possible to easily secure engagement between a tie rod and a half nut even if the tie rod to be engaged is bent. The half nut opening/closing device according to the present invention includes a half nut including a half nut piece and a half nut piece that are moved between a closed position and an open position and engage with a tie rod at the closed position, and an alignment roller that is provided on one or both of the half nut piece and the half nut piece, and is configured to convert moving force, of that the half nut piece and the half nut piece move to the closed position, into upward force in a vertical direction to lift and align the tie rod.

### TECHNICAL FIELD

The present invention relates to a half nut opening/closing device that is applied to a mold clamping apparatus for an injection molding machine, a diecasting machine, and the like.

### BACKGROUND ART

An injection molding machine and a diecasting machine each include a clamping apparatus for paired molds of a fixed mold and a movable mold. In a state where clamping force is applied to the paired molds by the clamping apparatus, a molten resin is injected into the molds in the injection molding machine, and a molten metal is pressed into the molds in the diecasting machine. The clamping force is applied through a tie rod that is bridged between the fixed mold and the movable mold. The clamping force is transmitted through engagement of an engagement portion provided on an outer peripheral surface of the tie rod with a half nut including paired half nut pieces provided in a movable mold platen. For a half nut opening/closing device, it is proposed that the paired right and left half nut pieces be opened and closed by a link mechanism in order to reduce the opening/closing time and the cost of the device (Patent Literature 1).

### CITATION LIST

### Patent Literature

Patent Literature 1: JP 2525885 B2

### SUMMARY OF INVENTION

### Technical Problem

The tie rod configuring the mold clamping apparatus includes a cantilever structure, and is accordingly bent (sagged) downward by its own weight in some cases. In particular, when the tie rod and the half nut engage with each other, the half nut is located at a free end part of the cantilevered tie rod. The free end part of the tie rod is a part where a bending amount in the cantilever state becomes the largest, and a center position of the free end part is eccentric downward from a support center position of the tie rod. In contrast, a center position of the half nut is concentrically provided with the support center position of the tie rod, namely the half nut is provided so as to engage with the tie rod that straightly extends along the horizontal direction without being bent. Therefore, when the tie rod is largely bent, the engagement position between the tie rod and the half nut is displaced and engagement does not occur.

An insertion member that causes the tie rod to be inserted into the movable mold platen so as not to get out of the movable mold platen in order to prevent sagging of the tie rod, and holds a tie rod shaft at an insertion portion of the movable mold platen even when the movable mold platen is moved to a position farthest from the fixed mold platen, may be provided. In this case, to suppress friction between an inner diameter of the insertion member and an outer diameter of the tie rod, a sliding member having a small friction coefficient is used as the insertion member. When the sliding abrasion of the insertion member is excessively progressed, however, a gap occurs between the insertion member and the tie rod, and the insertion member becomes unable to hold the tie rod shaft and to prevent the tie rod from being bent downward. This promotes deviation of the engagement position.

Accordingly, an object of the present invention is to provide a half nut opening/closing device that makes it possible to secure engagement between the tie rod and the half nut even if the tie rod to be engaged is bent.

### Solution to Problem

A half nut opening/closing device according to the present invention includes a half nut including a first half nut piece and a second half nut piece that are moved between a closed position and an open position in a horizontal direction and engage with a tie rod at the closed position, and an alignment mechanism that is provided on one or both of the first half nut piece and the second half nut piece, and is configured to convert moving force, of that the first half nut piece and the second half nut piece move to the closed position, into upward force in a vertical direction to lift and align the tie rod.

The half nut opening/closing device according to the present invention includes the alignment mechanism that lifts and aligns the tie rod. Therefore, even if the tie rod is bent, it is possible to cause the tie rod and the half nut to engage with each other. Further, the alignment mechanism according to the present invention converts the moving force, of that the first half nut piece and the second half nut piece move to the closed position, into upward force in the vertical direction, for serving as power sources to lift and align the tie rod. Therefore, the alignment mechanism makes it possible to align the tie rod without requiring a new power source for lifting the tie rod.

As the alignment mechanism according to the present invention, a rolling body rotatably provided on one or both of the first half nut piece and the second half nut piece may be used. According to the alignment mechanism, it is possible to align the tie rod only by providing the rolling body that is a simple member.

The rolling body according to the present invention comes into contact with one or both of a tooth and a groove of an engagement portion of the tie rod, to lift the tie rod. When the rolling body includes a shape corresponding to the tooth of the engagement portion, the rolling body easily comes into contact with the tooth. In contrast, when the rolling body includes a shape corresponding to the groove of the engagement portion, it is possible to increase the diameter of the rolling body. This reduces contact surface pressure between the rolling body and the tie rod, and accordingly reduces abrasion and depression.

Further, the rolling body according to the present invention includes a first rolling body and a second rolling body that is coaxially provided with the first rolling body and is larger in diameter than the first rolling body, and the first rolling body comes into contact with the tooth of the engagement portion, and the second rolling body comes into contact with the groove of the engagement portion. When this rolling body is used, the rolling body comes into contact with both of the tooth and the groove of the engagement portion of the tie rod. As a result, a load received by the entire rolling body is distributed, and abrasion of the rolling body is suppressed.

The alignment mechanism according to the present invention may include a link mechanism that is vertically moved along with opening/closing operation of the first half nut piece and the second half nut piece, and a support body that is supported by the link mechanism and lifts the tie rod. Also by the alignment mechanism using the link mechanism, it is possible to align the tie rod without providing a new power source for lifting the tie rod.

The link mechanism according to the present invention preferably includes a first link plate and a second link plate that each include one end swingably fixed to the first half nut piece and another end swingably fixed to the support body, and a third link plate that includes one end swingably fixed to the second half nut piece and another end swingably fixed to the support body.

According to the link mechanism, it is possible to reduce a length of each of the first to third link plates in an axis direction, as compared with a link mechanism in which link plates are provided so as to intersect with each other. Therefore, rigidity of the first to third link plates is easily secured. Further, the link mechanism includes the second link plate, which makes it possible to prevent inclination of the support body.

In addition, a surface of the support body contacted with the tie rod is made equal to or larger than a size of the cylindrical shape of the tie rod, which makes it possible to increase a contact area, and the support body comes into contact with the tie rod without being slipped. Therefore, it is possible to prevent abrasion of the contact surface between the support body and the tie rod.

### Advantageous Effects of Invention

According to the present invention, it is possible to provide the half nut opening/closing device that makes it possible to secure engagement between the tie rod and the half nut even if the tie rod to be engaged is bent. In addition, the alignment mechanism according to the present invention converts the moving force, of that the first half nut piece and the second half nut piece move to the closed position, into upward force in the vertical direction, for serving as the power source to lift and align the tie rod. Therefore, it is unnecessary to provide a new power source for lifting the tie rod.

### BRIEF DESCRIPTION OF DRAWINGS

FIG. 1 is a partial cross-sectional view illustrating a schematic configuration of a mold clamping apparatus according to an embodiment of the present invention.

FIGS. 2A to 2C each illustrate a half nut opening/closing device according to a first embodiment of the present invention, FIG. 2A being a perspective view illustrating a whole of the half nut opening/closing device, FIG. 2B being a plan view of a half nut located at an open position, and FIG. 2C being a plan view of the half nut when the half nut reaches a closed position.

FIGS. 3A to 3C each illustrate a schematic configuration of a tie rod and the half nut in the half nut opening/closing device of FIG. 2 as viewed from a front side, FIG. 3A illustrating a state where the half nut is located at the open position, FIG. 3B illustrating a state where the half nut reaches the closed position, and FIG. 3C illustrating an example in which alignment rollers are symmetrically provided.

FIGS. 4A and 4B each illustrate a state where the tie rod and the half nut engage with each other in the half nut opening/closing device of FIG. 2, FIG. 4A illustrating a cross-section taking along a line A-A of FIG. 3 when the half nut is located at the open position, and FIG. 4B illustrating a cross-section taking along a line B-B of FIG. 3 when the half nut reaches the closed position.

FIG. 5 is a diagram illustrating a modification of the first embodiment.

FIGS. 6A and 6B each illustrate another modification of the first embodiment, FIG. 6A being a front view, and FIG. 6B being a diagram illustrating a state where a tie rod and a half nut engage with each other.

FIGS. 7A and 7B each illustrate still another modification of the first embodiment, FIG. 7A being a front view, and FIG. 7B being a diagram illustrating a state where a tie rod and a half nut engage with each other.

FIGS. 8A and 8B each illustrate a structure of a half nut opening/closing device of FIG. 7, FIG. 8A being a vertical cross-sectional view, and FIG. 8B being an exploded perspective view.

FIGS. 9A to 9C each illustrate a half nut opening/closing device according to a second embodiment of the present invention, FIG. 9A being a front view when the half nut opening/closing device is open, FIG. 9B being a front view when the half nut opening/closing device is closed, and FIG. 9C being a cross-sectional view taken along a line 9c-9c of FIG. 9B.

### DESCRIPTION OF EMBODIMENTS

### First Embodiment

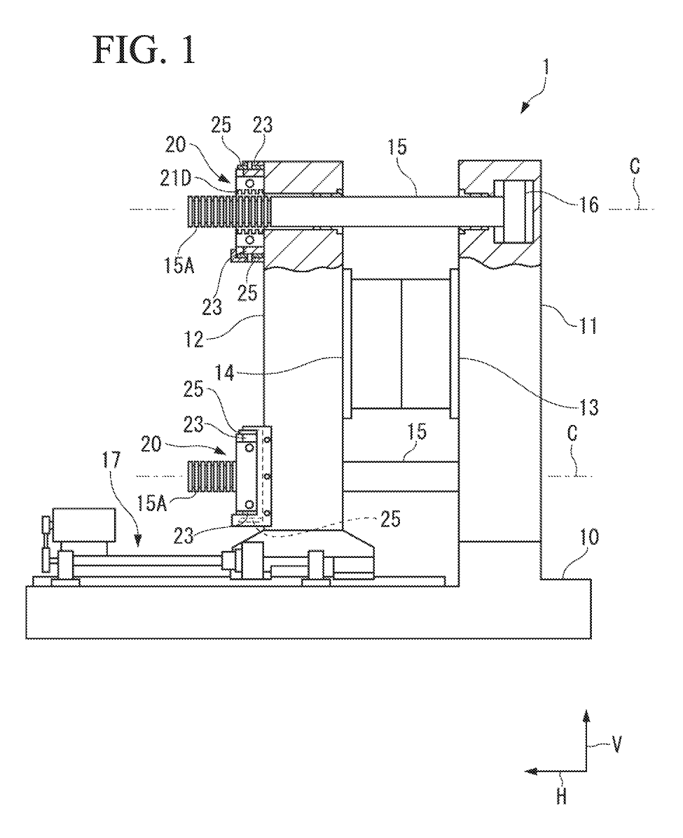

A first embodiment of the present invention is described below with reference to FIG. 1 to FIG. 7.

As illustrated in FIG. 1, a mold clamping apparatus 1 according to the present embodiment includes a base 10, a fixed mold platen 11, a movable mold platen 12, tie rods 15, movable mold platen moving means 17, and a half nut opening/closing device 20.

The fixed mold platen 11 is provided on one end side of the base 10, and the movable mold platen 12 is disposed so as to be slidable to the base 10 and to face the fixed mold platen 11.

A fixed mold 13 is attachable to the fixed mold platen 11, a movable mold 14 is attachable to the movable mold platen 12, and the fixed mold 13 and the movable mold 14 form therein a cavity into which a molten resin is injected.

The fixed mold platen 11 and the movable mold platen 12 are connected by the four tie rods 15 that are adjacent to one another in a horizontal direction H and in a vertical direction V.

The four tie rods 15 are disposed to penetrate through respective four corners of the movable mold platen 12, and the movable mold platen 12 is slidable to the tie rods 15. Sliding material (insertion members) to suppress friction between the tie rods 15 and the movable mold platen 12 may be interposed therebetween. In addition, at this time, when the movable mold platen 12 is moved to a position farthest from the fixed mold platen 11, the tie rods 15 may get out of the movable mold platen 2, or the tie rods 15 may maintain the state of being inserted into the movable mold platen 2 without getting out of the movable mold platen 2.

Each of the tie rods 15 includes a piston 16 for generating clamping force on fixed mold platen 11 side, and is provided with an engagement portion 15A that communicates, in a circumferential direction, with an end part on an opposite side of the fixed mold platen 11. The engagement portion 15A may include a spiral shape in which adjacent grooves or adjacent tooth are all connected to each other, or a shape in which ring shapes are arranged in an axis direction, and grooves or teeth are adjacent to each other without being connected.

Further, the base 10 includes, for example, the electric or hydraulic movable mold platen moving means 17 that reciprocates the movable mold platen 12 with respect to the fixed mold platen 11. FIG. 1 illustrates a mold closed state in which the movable mold platen 12 has been moved toward the fixed mold platen 11 by the movable mold platen moving means 17 and the movable mold 14 has been brought into contact with the fixed mold 13.

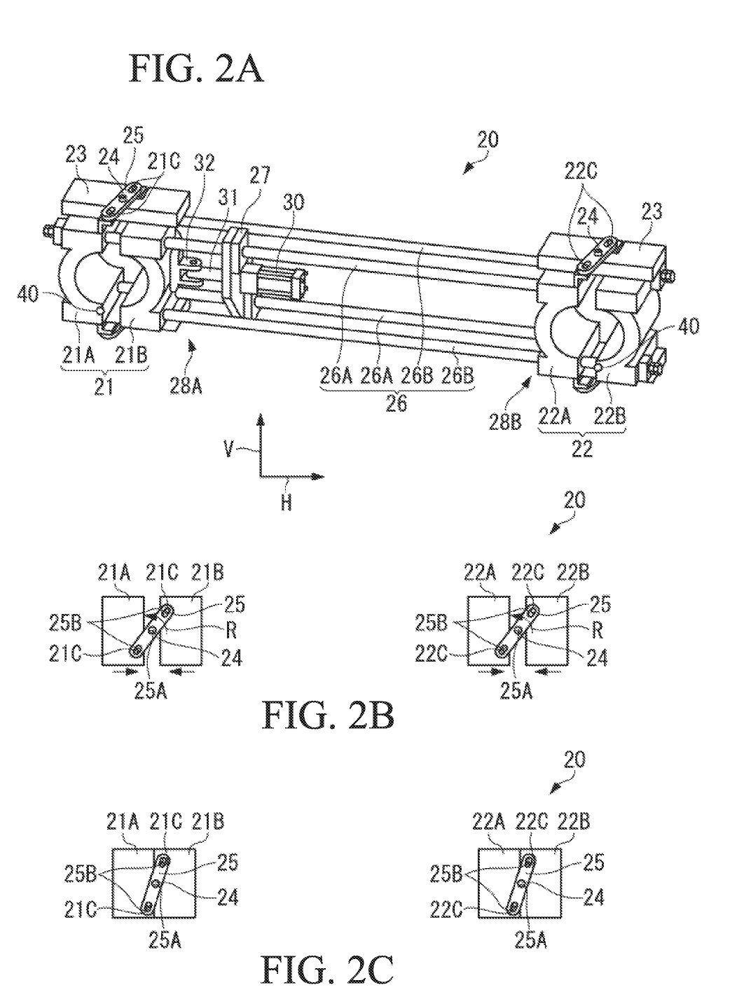

As illustrated in FIG. 1 and FIG. 2A, the half nut opening/closing device 20 includes a half nut 21, a half nut 22, guide boxes 23, link plates 25, and a coupling rod 26. The half nut opening/closing device 20 is provided in each of upper and lower stages on a surface of the movable mold platen 12 on side opposite to the side provided with the movable mold 14. Among the four tie rods 15, two tie rods 15 and 15 on upper side correspond to the half nut opening/closing device 20 on the upper stage, and two tie rods 15 and 15 on lower side correspond to the half nut opening/closing device 20 on the lower stage.

As illustrated in FIGS. 2A to 2C, the half nut 21 includes a half nut piece (first half nut piece) 21A and a half nut piece (second half nut piece) 21B. The half nut 21 holds the corresponding tie rod 15 through engagement between engagement portions 21D and 21D (FIG. 1) of the respective half nut pieces 21A and 21B and the engagement portion 15A of the corresponding tie rod 15.

Further, as illustrated in FIGS. 2A to 2C, the half nut 22 includes a half nut piece 22A and a half nut piece 22B. The half nut 22 also holds the corresponding tie rod 15 through engagement between engagement portions 21D and 21D (FIG. 1) of the respective half nut pieces 22A and 22B and the engagement portion 15A of the corresponding tie rod 15.

Note that the half nut 21 and the half nut 22 each include a substantially vertically-symmetric structure, and FIGS. 2B and 2C illustrate both of a top surface and a bottom surface thereof. Alternatively, the half nut 21 and the half nut 22 may include a vertically-asymmetric structure.

As illustrated in FIG. 1 and FIGS. 2A and 2B, the half nut piece 21A and the half nut piece 21B are disposed inside the corresponding guide box 23 provided on the movable mold platen 12 so as to be slidable in the horizontal direction H. Further, the half nut piece 21A and the half nut piece 21B are each coupled to an outside of the corresponding guide box 23 through the corresponding link plates 25 that are respectively supported on upper and lower surfaces of the guide box 23 in the figure. Further, each of the link plates 25 swings around a fulcrum pin 24 that protrudes upward or downward at a position of a center axis C (FIG. 1) of the corresponding tie rod 15. The link plates 25 are respectively provided on upper surface side and lower surface side of the half nut 21. In addition, the fulcrum pin 24 protrudes upward on the upper surface side of the half nut 21, and the fulcrum pin 24 protrudes downward on the lower surface side of the half nut 21.

As illustrated in FIGS. 2A and 2B, the half nut 22 including the half nut piece 22A and the half nut piece 22B also includes a similar configuration.

As a result, opening/closing operation of the half nut piece 21A and the half nut piece 21B, and opening/closing operation of the half nut piece 22A and the half nut piece 22B with respect to the tie rods 15 are synchronized with each other.

As illustrated in FIGS. 2A to 2C, support pins 21C are provided on the upper and lower surfaces of the half nut piece 21A and the half nut piece 21B so as to protrude upward and downward.

Likewise, support pins 22C are provided on the upper and lower surfaces of the half nut piece 22A and the half nut piece 22B so as to protrude upward and downward.

Note that the support pins 21C protrude upward on the upper surfaces of the half nut piece 21A and the half nut piece 21B, and the support pins 21C protrude downward on the lower surfaces of the half nut piece 21A and the half nut piece 21B. Likewise, the support pins 22C protrude upward on the upper surfaces of the half nut piece 22A and the half nut piece 22B, and the support pins 22C protrude downward on the lower surfaces of the half nut piece 22A and the half nut piece 22B.

Each of the link plates 25 includes a round hole 25A at a center, and includes two long holes 25B at respective end parts symmetric about the round hole 25A. The fulcrum pin 24 that protrudes outward from the guide box 23 is inserted into the round hole 25A of the link plate 25.

Further, the support pins 21C on the upper and lower sides of the half nut piece 21A and the half nut piece 21B, and the support pins 22C on the upper and lower sides of the half nut piece 22A and the half nut piece 22B are inserted into the corresponding long holes 25B at both end parts of the link plates 25. Note that, in the figure, the example in which the link plates 25 are provided outside the guide boxes 23 has been illustrated; however, the link plates 25 may be provided between each of the guide boxes 23 and the corresponding half nut.

As illustrated in FIG. 2A, the coupling rod 26 includes two first coupling rods 26A and two second coupling rods 26B. The first coupling rods 26A each slidably penetrate through the half nut piece 21B to couple the half nut piece 21A and the half nut piece 22A to each other. The second coupling rods 26B each slidably penetrate through the half nut piece 22A to couple the half nut piece 21B and the half nut piece 22B.

Note that the half nut piece 21A, the half nut piece 22A, and the two first coupling rods 26A that couple the half nut piece 21A and the half nut piece 22A integrally operate the half nut piece 21A and the half nut piece 22A.

Further, the half nut piece 21B, the half nut piece 22B, and the two second coupling rods 26B that couple the half nut piece 21B and the half nut piece 22B integrally operate the half nut piece 21B and the half nut piece 22B.

Moreover, as illustrated in FIG. 1, a bracket 27 is provided on the coupling rod 26 between the half nut piece 21B and the half nut piece 22A. A hydraulic cylinder 30 serving as an actuator is attached to the bracket 27. Further, the bracket 27 is fixed to the two first coupling rods 26A.

A piston rod 31 of the hydraulic cylinder 30 is coupled to the half nut piece 21B through a clevis 32 that includes a swing shaft in the vertical direction V. Even if the half nut piece 21B is inclined, the inclination is absorbed by rotation of the clevis 32 to prevent bending force from occurring on the piston rod 31. The hydraulic cylinder 30 may be replaced with an actuator driven by an electric motor.

Further, for example, in a case where a space between the half nut 21 and the half nut 22 is not enough to install the coupling rod 26, or in a case where the half nuts 21 and 22 are individually opened and closed, the half nut 21 and the half nut 22 may not be coupled by the coupling rod 26, and half nut opening/closing means may be separately provided to each of the half nut 21 and the half nut 22 to perform the opening/closing operation.

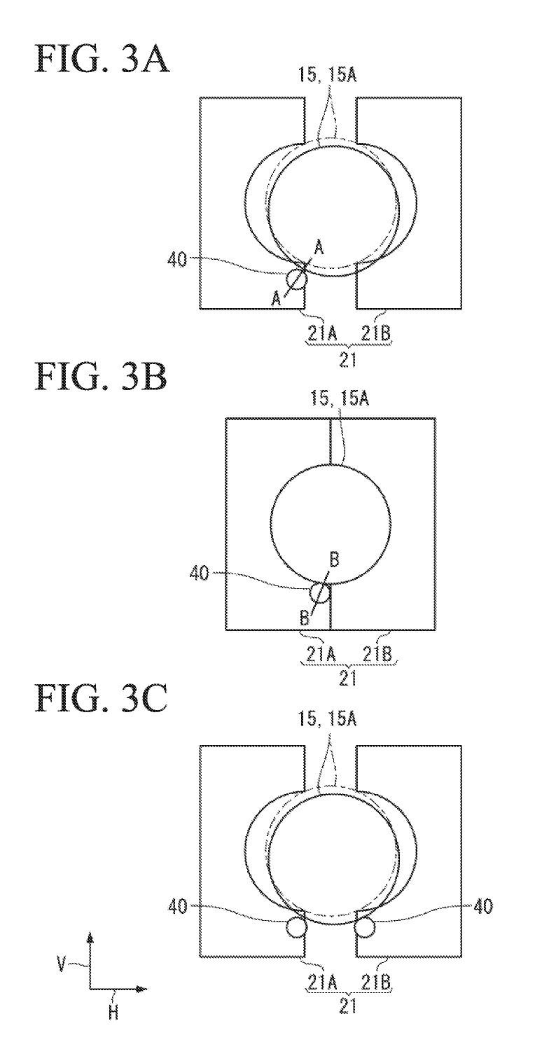

As illustrated in FIG. 2A and FIG. 3, the half nut piece 21A of the half nut 21 and the half nut piece 22B of the half nut 22 each include an alignment roller 40 serving as an alignment mechanism. The alignment roller 40 is provided to secure engagement of each of the half nut 21 and the half nut 22 with the corresponding tie rod 15 even if the tie rod 15 is bent downward. In the following, the alignment roller 40 provided on the half nut piece 21A of the half nut 21 is described as an example of the alignment roller 40.

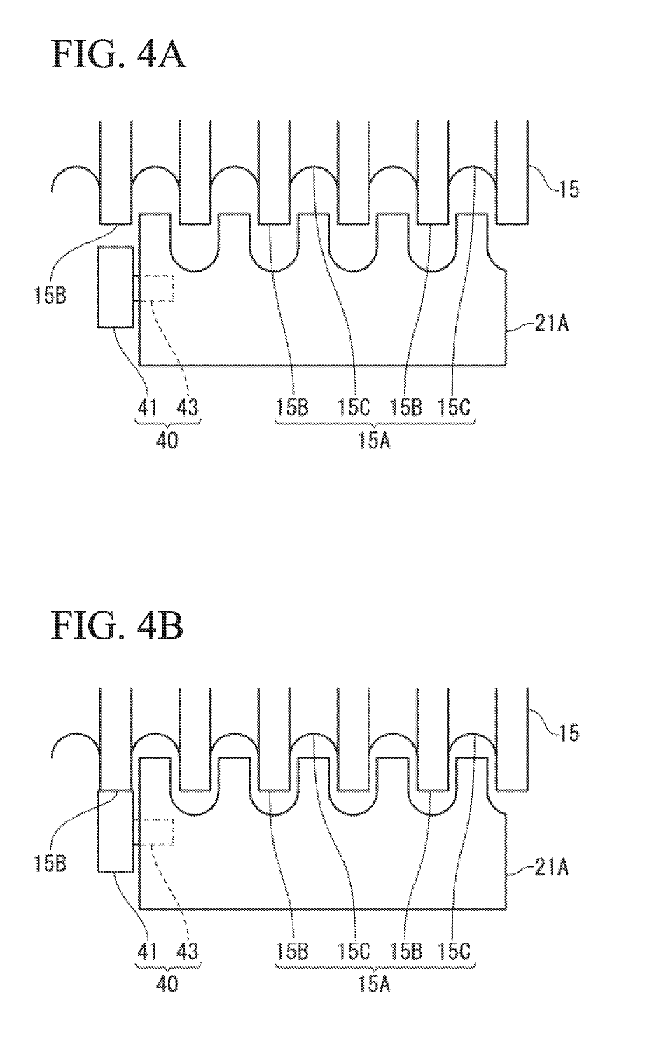

As illustrated in FIGS. 2 to 4, the alignment roller 40 is provided near a lower end of an inner diameter on one end surface of the half nut piece 21A. As illustrated in FIG. 4, the alignment roller 40 includes a roller body 41 serving as a rolling body, and a columnar support shaft 43 that is coaxially provided with the roller body 41. The roller body 41 and the support shaft 43 are mutually rotatable. As the alignment roller 40, a cam follower may be used. The cam follower indicates a bearing that includes a needle bearing and includes the high-rigidity support shaft 43. The cam follower, however, is an example of the alignment roller 40, and for example, the alignment roller 40 in which the roller body 41 and the support shaft 43 are integrally formed may be used and the support shaft 43 may be rotatably attached to the half nut piece 21A through a rolling bearing, a radial bearing, or the like.

The support shaft 43 is embedded in the half nut piece 21A, which fixes the alignment roller 40 to the half nut piece 21A. Accordingly, as illustrated in FIGS. 3A and 3B, when the half nut piece 21A performs opening/closing operation, the alignment roller 40 integrally operates with the half nut piece 21A and is moved in the horizontal direction H. In particular, when the half nut piece 21A performs the closing operation, the alignment roller 40 comes into contact with the tie rod 15 that is bent downward in the vertical direction V, from the lower side in the vertical direction V to lift the tie rod 15. Since the roller body 41 is rotatable with respect to the support shaft 43, the roller body 41 in contact with the tie rod 15 rolls and lifts the tie rod 15 while the roller body 41 does not slip or slightly slip on the tie rod 15.

The tie rod 15 is ideally lifted in a direction coincident with the vertical direction V. However, although the half nut pieces 21A and 21B symmetrically push the tie rod 15 from both sides in the horizontal direction H, the tie rod 15 is actually lifted obliquely upward deviated from the vertical direction V by a little amount in some cases because the half nut piece 21A is moved in the horizontal direction H. Also in this case, the tie rod 15 is still lifted upward in the vertical direction V.

Next, action of the half nut opening/closing device 20 is described with reference to FIG. 2A to FIG. 4B.

First, when the mold is closed by the movable mold platen moving means 17, the engagement portions 15A of the tie rods 15 are placed in the half nut 21 (between half nut pieces 21A and 21B) and in the half nut 22 (between half nut pieces 22A and 22B) that are located on the open position.

Next, when the piston rod 31 of the hydraulic cylinder 30 is advanced, the half nut piece 21B is moved leftward in FIG. 2A, and the half nut piece 21A is moved rightward in FIG. 2A due to reaction force through the two first coupling rods 26A and the bracket 27 that is fixed to the hydraulic cylinder 30. At this time, the half nut piece 22A and the half nut piece 21A are coupled by the two first coupling rods 26A, and the half nut piece 22B and the half nut piece 21B are coupled by the two second coupling rods 26B. Accordingly, the half nut pieces 22A and 22B are respectively moved in the direction same as the moving directions of the half nut pieces 21A and 21B, and come close to the tie rods 15 and 15.

At this time, as illustrated in FIG. 2B, the link plates 25 connected to the half nuts 21 and 22 rotate in an arrow R direction around the fulcrum pins 24. Further, the half nut pieces 21A and 22A come close to the tie rods 15 in synchronization with the half nut pieces 21B and 22B at the same time.

The half nut piece 21A and the half nut piece 21B, and the half nut piece 21A and the half nut piece 21B integrally operate with the corresponding tie rods 15 to further come close to the corresponding tie rods 15. As a result, each of the half nuts 21 and 22 engages with the corresponding tie rod 15 and holds the corresponding tie rod 15.

On the other hand, the half nut pieces 21A and 21B start the closing operation. At this time, as illustrated in FIG. 3A, the tie rod 15 is bent downward from a regular position illustrated by an alternate long and short dash line. In addition, as illustrated in FIG. 4A, the alignment roller 40 is separated from a corresponding tooth 15B of the tie rod 15. When the closing operation is progressed, the alignment roller 40 starts to contact with the bent tie rod 15. At this time, when the tie rod 15 is largely bent, the teeth of the engagement portions of the respective half nut pieces 21A and 21B do not reach positions where the teeth of the engagement portions sufficiently enter a groove 15C of the engagement portion 15A of the tie rod 15, and the half nut pieces 21A and 21B and the tie rod 15 may not sufficiently engage with each other. In this state, as the closing operation of the half nut pieces 21A and 21B is progressed, the tie rod 15 is lifted by the alignment roller 40. When the half nut pieces 21A and 21B reach a closed position, the half nut piece 21A lifts and aligns the tie rod 15 to the regular position as illustrated in FIG. 3B and FIG. 4B. The regular position indicates a position of the tie rod 15 that is not bent.

The specification, the attachment position to the half nut piece 21A, etc. of the alignment roller 40 are considered in order to exert the above-described alignment function. In the above-described embodiment, the alignment roller 40 is provided only on the half nut piece 21A on one side; however, the alignment roller 40 is preferably provided at a line-symmetric position on the half nut piece 21B that faces the half nut piece 21A as illustrated in FIG. 3C, in addition to the half nut piece 21A. As a result, the tie rod 15 is pushed from both sides in the horizontal direction H and is lifted upward in the vertical direction V. Accordingly, the tie rod 15 is stably operated without swinging in the horizontal direction H caused to generate collision sound, uneven abrasion, and the like.

As described above, the alignment roller 40 functions as the alignment mechanism that converts moving force, of that the first half nut piece 21A and the second half nut piece 21B move to the closed position, into the upward force in the vertical direction V to lift the tie rod 15.

Next, effects achieved by the half nut opening/closing device 20 are described.

As described above, the half nut opening/closing device 20 includes the alignment roller 40 in each of the half nut piece 21A and the half nut piece 22B, and aligns the bent tie rods 15 to the respective regular positions when the half nut 21 and the half nut 22 reach the closed positions. This makes it possible to secure engagement of the half nuts 21 and 22 with the tie rods 15.

Further, the half nut opening/closing device 20 includes the alignment roller 40 in each of the half nut piece 21A and the half nut piece 22B, and the alignment rollers 40 are moved integrally with the closing operation of the half nut 21 and the half nut 22. In other words, since the half nut piece 21A and the half nut piece 22B serve as power sources, the half nut opening/closing device 20 can align the bent tie rod 15 to the regular position without being provided with a new power source.

Further, in the half nut opening/closing device 20, the roller body 41 of the alignment roller 40 that lifts the tie rod 15 rolls while the roller body 41 does not slip or slightly slips on the tie rod 15 when the roller body 41 comes into contact with the tie rod 15. This makes it possible to suppress abrasion between the roller body 41 and the tie rod 15.

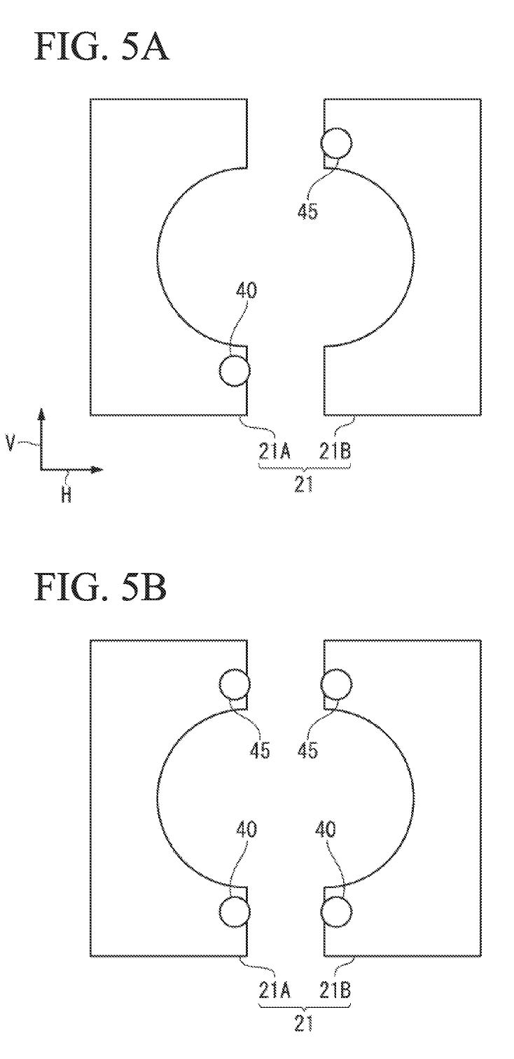

The half nut opening/closing device 20 according to the above-described first embodiment includes the alignment roller 40 on the lower side of the half nut piece 21A. Accordingly, the tie rod 15 is displaced not only upward in the vertical direction V but also in the horizontal direction, namely, rightward in the example of FIG. 3. Thus, as illustrated in FIGS. 5A and 5B, an alignment roller 45 may be provided on the half nut piece 21B facing the half nut piece 21A. For example, as illustrated in FIG. 5A, the alignment roller 45 is provided at a position point-symmetric to the position of the alignment roller 40. As a result, the tie rod 15 that receives upward and rightward force when coming into contact with the alignment roller 40, receives downward and leftward force when coming into contact with the alignment roller 45. Accordingly, the tie rod 15 is vertically sandwiched and positioned while both forces are cancelled. This makes it possible to achieve more accurate alignment. This is true of the half nut piece 22A and the half nut piece 22B.

Further, in the half nut opening/closing device 20 according to the first embodiment, the alignment roller 40 comes into contact with the tooth 15B of the engagement portion 15A of the tie rod 15; however, the present invention is not limited thereto.

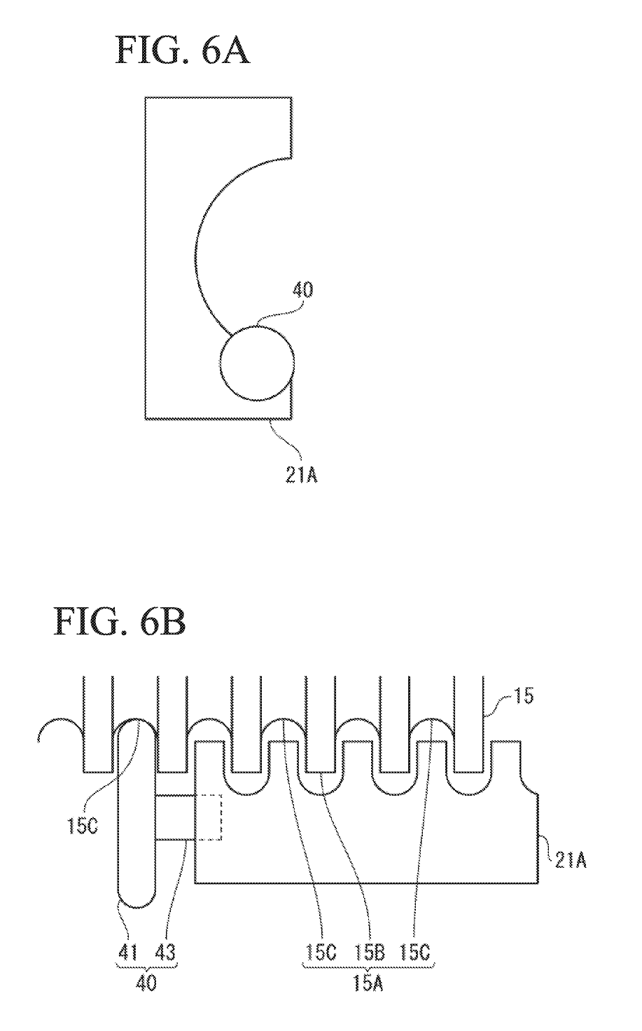

For example, as illustrated in FIG. 6, the alignment roller 40 may come into contact with a groove 15C of the engagement portion 15A of the tie rod 15. Comparing a case where the alignment roller 40 comes into contact with the tooth 15B of the tie rod 15 with a case where the alignment roller 40 comes into contact with the groove 15C of the tie rod 15, the alignment roller 40 easily comes into contact with the tooth 15B because the tooth 15B is located at the outermost periphery. In contrast, in the case where the alignment roller 40 comes into contact with the groove 15C, it is possible to increase a diameter of the alignment roller 40. This reduces contact surface pressure between the alignment roller 40 and the tie rod 15, and as a result, abrasion and depression are advantageously reduced.

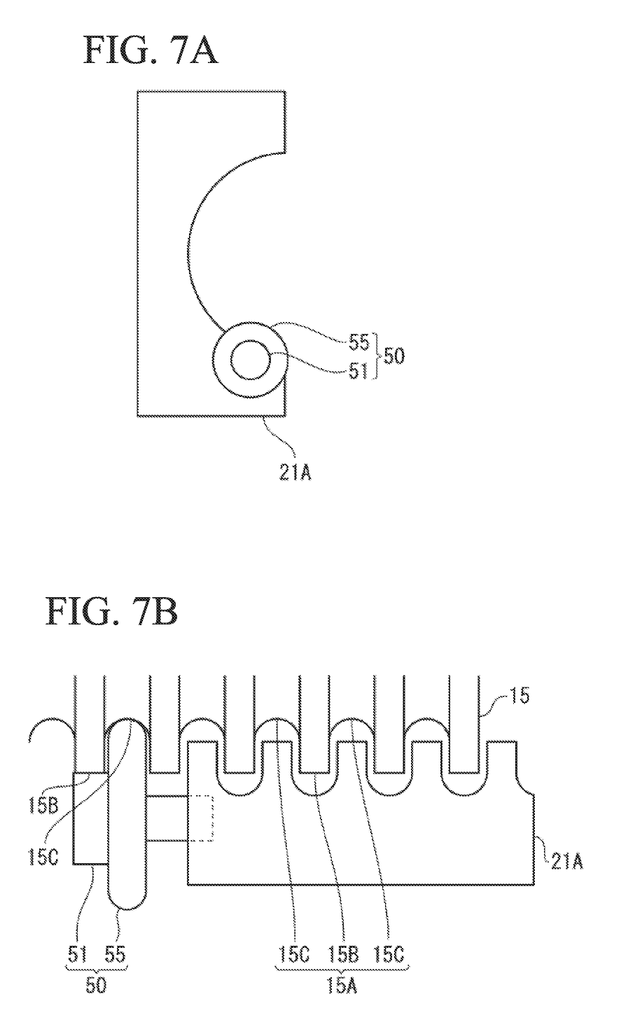

Further, for example, as illustrated in FIG. 7, an alignment roller 50 that comes into contact with both of the tooth 15B and the groove 15C adjacent to each other of the engagement portion 15A of the tie rod 15 may be used.

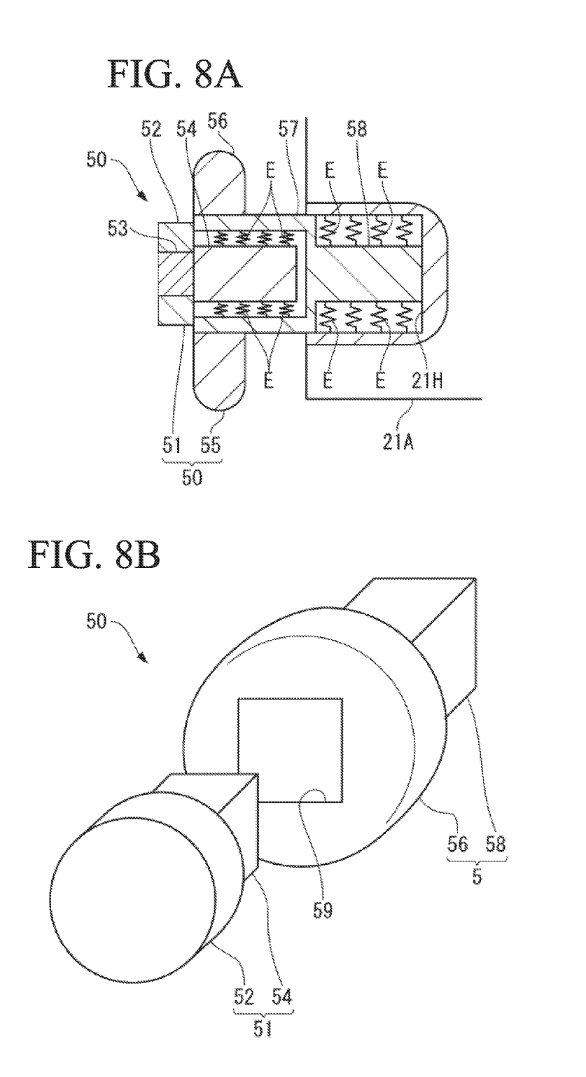

As illustrated in FIG. 7 and FIG. 8, the alignment roller 50 includes a first roller (first rolling body) 51 and a second roller (second rolling body) 55 that is larger in diameter than the first roller 51. The first roller 51 and the second roller 55 are coaxially provided, the first roller 51 comes into contact with the tooth 15B of the engagement portion 15A, and the second roller 55 comes into contact with the groove 15C of the engagement portion 15A.

The first roller 51 and the second roller 55 each include a cam follower as with the alignment roller 40.

The first roller 51 includes a roller body 52, a columnar first support body 53 that is coaxially provided with the roller body 52, and a quadrangular prism-shaped second support body 54 that is coaxially provided with the roller body 52. In the first roller 51, the roller body 52 is supported so as to be rotatable with respect to the first support body 53, whereas the first support body 53 and the second support body 54 are coupled to each other so as not to be rotatable.

Further, the second roller 55 includes a roller body 56, a columnar first support body 57 that is coaxially provided with the roller body 56, and a quadrangular prism-shaped second support body 58 that is coaxially provided with the roller body 56. In the second roller 55, the roller body 56 is supported so as to be rotatable with respect to the first support body 57, whereas the first support body 57 and the second support body 58 are coupled to each other so as not to be rotatable.

The second roller 55 includes, in the first support body 57, a holding hole 59 that accommodates and holds the second support body 54 of the first roller 51.

In the alignment roller 50, the second support body 58 of the second roller 55 is held by a holding hole 21H provided in the half nut piece 21A, and the second support body 54 of the first roller 51 is held by the holding hole 59 of the second roller 55. The second support body 58 is supported through an elastic body E inside the holding hole 21H, and the second support body 54 is supported through an elastic body E inside the holding hole 59. At this time, the first support body 57 or the second support body 54 or both of the first support body 57 and the second support body 54 may be formed of a processed high-elastic material to include a function of the elastic body E.

In the alignment roller 50, the first roller 51 comes into contact with the tooth 15B of the engagement portion 15A, and the second roller 55 comes into contact with the groove 15C of the engagement portion 15A as well. Accordingly, as compared with a case of contact only by the tooth 15B or only by the groove 15C, a surface receiving a load from the tie rod 15 is shared by the first roller 51 and the second roller 55. This makes it possible to suppress abrasion of each of the first roller 51 and the second roller 55 due to contact with the tie rod 15.

Further, since the alignment roller 50 is supported by the elastic body E, it is possible to surely bring the first roller 51 into contact with the tooth 15B and to surely bring the second roller 55 into contact with the groove 15C.

Further, as the support member of the alignment roller 50 according to the first embodiment, the first support body rotatably supporting the roller body and the second support body unrotatably coupled with the first support body that are included in each of the first roller 51 and the second roller 55 have been described; however, the present invention is not limited thereto. It is sufficient for the support member of the alignment roller 50 to include a structure that rotatably supports the roller bodies and can individually slightly move the roller bodies in a radial direction in order to adjust the positions of the roller bodies such that the roller bodies come into contact with and support the engagement portion of the tie rod 15 at the same time.

Note that, although not illustrated, the alignment roller may be configured such that one roller comes into contact with a plurality of, for example, two teeth 15B, or the alignment roller may be configured such that independent rollers come into contact with a plurality of, for example, two teeth 15B. Alternatively, two alignment rollers may be configured so as to come into contact with a plurality of, for example, two grooves 15C, or alignment rollers may be configured so as to independently come into contact with a plurality of, for example, two grooves 15C.

### Second Embodiment

Next, a half nut opening/closing device 60 according to a second embodiment of the present invention is described.

In the half nut opening/closing device 60 according to the second embodiment, a link lift mechanism 70 that is provided between the half nut piece 21A and the half nut piece 21B lifts the tie rod 15. In this example, the link lift mechanism 70 provided on one half nut 21 is described; however, the link lift mechanism 70 is similarly provided on each of the other half nut 21 and the half nuts 22.

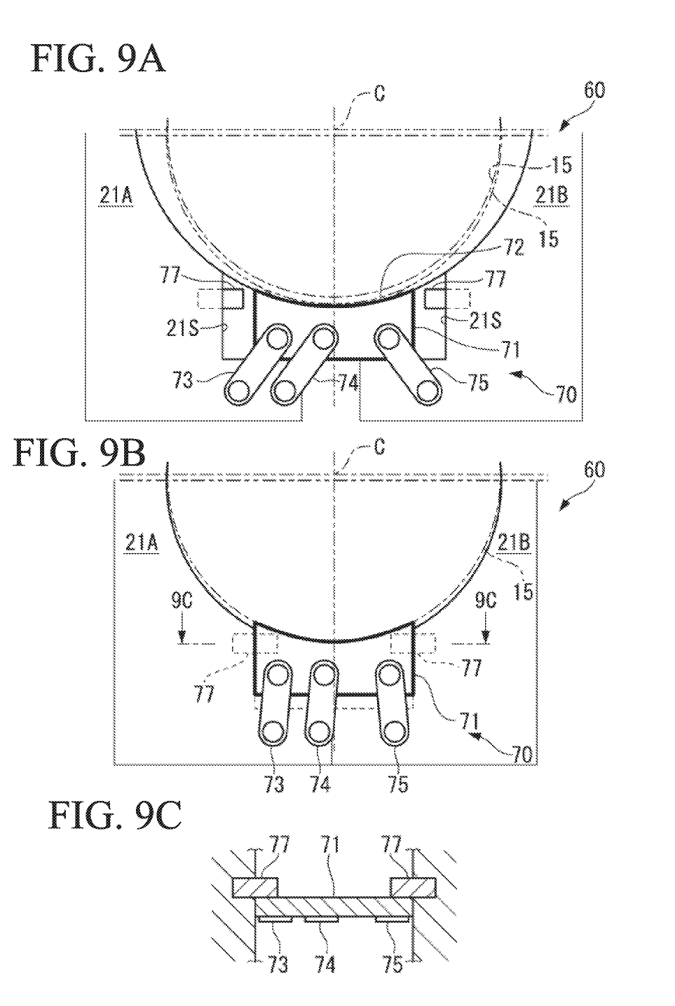

As illustrated in FIG. 9, the link lift mechanism 70 includes a support body 71, and a first link plate 73, a second link plate 74, and a third link plate 75 that vertically move the support body 71. The link lift mechanism 70 lifts the corresponding tie rod 15 according to the closing operation of the half nut piece 21A and the half nut piece 21B.

As illustrated in FIGS. 9A and 9B, the support body 71 includes a substantially rectangular shape as viewed from a front side, and a part of the support body 71 coming into contact with the tie rod 15 includes an arc-shaped support surface 72 matched with a curvature of the outer periphery of the tie rod 15. When the support body 71 is moved upward along with the closing operation of the half nut 21, the support surface 72 comes into contact with the bent tie rod 15 and lifts the tie rod 15 along with progress of the closing operation. Note that, in FIG. 9, the tie rod 15 that is not bent at the regular position is illustrated by an alternate long and short dash line, and the bent tie rod 15 is illustrated by an alternate long and two short dashes line.

The half nut piece 21A and the half nut piece 21B respectively include movable spaces 21S and 21S for accommodating the support body 71. The movable spaces 21S and 21S are formed by cutting out parts of the half nut piece 21A and the half nut piece 21B facing each other. The support body 71 is disposed over the movable spaces 21S and 21S.

Next, the first link plate 73 and the second link plate 74 each include one end on upper end side that is swingably fixed to the support body 71, and the other end on lower end side that is swingably fixed to the half nut piece 21A. As illustrated in FIG. 9A, the first link plate 73 and the second link plate 74 are each inclined such that the upper end is closer to the center axis C of the tie rod 15 than the lower end when the half nut 21 is located at the open position. The third link plate 75 is different in inclination direction from the first link plate 73 and the second link plate 74. The inclination directions are maintained when the half nut 21 reaches the closed position.

The third link plate 75 includes one end on upper end side that is swingably fixed to the support body 71, and one end on lower end side that is swingably fixed to the half nut piece 21A. As illustrated in FIG. 9A, the third link plate 75 is inclined such that the upper end is closer to the center axis C of the tie rod 15 than the lower end when the half nut 21 is located at the open position. The inclination direction is maintained when the half nut 21 reaches the closed position.

The link lift mechanism 70 includes fall preventive members 77 that prevent the support body 71 from being inclined in a direction of the center axis C of the tie rod 15. Base end parts of the fall preventive members 77 are embedded in the half nut piece 21A and the half nut piece 21B. During the closing operation of the half nut 21, parts of the fall preventive members 77 protruded from the half nut piece 21A and the half nut piece 21B are locked by the support body 71. In FIG. 9C, the fall preventive members 77 are in contact with a rear surface of the support body 71 to prevent falling of the support body 71. Alternatively, unillustrated support holes to which the fall preventive members 77 are insertable may be provided in the support body 71, and the fall preventive members 77 may be inserted into the support holes during the closing operation of the half nut 21 to prevent falling of the support body 71.

The link lift mechanism 70 operates in the following manner.

When the closing operation is started from the open position of the half nut 21 as illustrated in FIG. 9A and the half nut piece 21A and the half nut piece 21B come close to each other, the inclination angle of each of the first link plate 73, the second link plate 74, and the third link plate 75 with respect to the horizontal direction H is increased. Along with the operation, the support body 71 is moved upward from an initial position while maintaining the horizontal state, and the support surface 72 comes into contact with the bent tie rod 15. When the closing operation is further progressed and the half nut 21 reaches the closed position as illustrated in FIG. 9B, the tie rod 15 is aligned to the regular position.

As described above, the half nut opening/closing device 60 according to the second embodiment includes the link lift mechanism 70 in each of the half nuts 21 and 22, and aligns the corresponding bent tie rod 15 to the regular position when the half nut pieces 21A, 21B, 22A, and 22B reach the closed position. Therefore, the half nut opening/closing device 60 can cause each of the half nuts 21 and 22 and the tie rod 15 to surely engage with each other.

Moreover, in the half nut opening/closing device 60, the link lift mechanism 70 is provided between the half nut piece 21A and the half nut pieces 21B, and is moved along with the closing operation of the half nut 21. Accordingly, the half nut opening/closing device 60 can align the bent tie rod 15 to the regular position without requiring a new power source.

At this time, it is sufficient for the link lift mechanism 70 to include the two link members of the first link plate 73 and the third link plate 75 only for vertically moving the support body 71; however, the support body 71 is not supported in parallel with the horizontal direction H only by the two link members, and the support body 71 may be inclined. In contrast, since the link lift mechanism 70 includes the second link plate 74, it is possible to support the support body 71 in parallel with the horizontal direction H.

Furthermore, the link lift mechanism 70 includes the fall preventive members 77 that prevent the support body 71 from being inclined to the axis direction of the tie rod 15. Accordingly, it is possible to more surely secure engagement between the tie rod 15 and each of the half nuts 21 and 22.

Although the present invention has been described above based on the preferred embodiments, the configurations described in the above-described embodiments may be selected or appropriately modified without departing from the scope of the present invention.

For example, the roller body 41 of the alignment roller 40 as the rolling body includes a circular outer peripheral shape in the first embodiment; however, the present invention is not necessarily limited thereto. The effects of the present invention are achievable even by, for example, a rolling body including a polygonal outer peripheral shape, a rolling body including an elliptical outer peripheral shape, or a structure in which the support shaft 4 is provided at a position eccentric from a center of the roller body 41.

Further, as the link lift mechanism according to the second embodiment, a mechanism in which two link plates intersect with each other may be used. According to the link mechanism, it is possible to maintain a horizontal attitude of the support body 71 without providing a link plate corresponding to the second link plate 74 according to the second embodiment. In the link mechanism in which the two link plates intersect with each other, however, a dimension of each of the two link plates is large in the axis direction, and it is therefore necessary to secure rigidity necessary for lifting the tie rod 15. This indicates that the dimension of each of the first link plate 73 to the third link plate 75 in the axis direction is small and that rigidity is easily secured in the second embodiment including the three link plates of the first link plate 73 to the third link plate 75.

### REFERENCE SIGNS LIST

1 Mold clamping apparatus
10 Base
11 Fixed mold platen
12 Movable mold platen
13 Fixed mold
14 Movable mold
15 Tie rod
15A Engagement portion
20 Half nut opening/closing device
21 Half nut
21A, 21B Half nut piece
22 Half nut
22A, 22B Half nut piece
40 Alignment roller
41 Roller body
43 Support shaft
50 Alignment roller
51 First roller
52 Roller body
53 First support body
54 Second support body
55 Second roller
56 Roller body
57 First support body
58 Second support body
59 Holding hole
60 Half nut opening/closing device
70 Link lift mechanism
71 Support body
72 Support surface
73 First link plate
74 Second link plate
75 Third link plate
77 Fall preventive member

1. A half nut opening/closing device, comprising:
a half nut including a first half nut piece and a second half nut piece that are moved between a closed position and an open position in a horizontal direction and engage with a tie rod at the closed position; and
an alignment mechanism that is provided on one or both of the first half nut piece and the second half nut piece, and is configured to convert moving force, of that the first half nut piece and the second half nut piece move to the closed position, into upward force in a vertical direction to lift and align the tie rod.

2. The half nut opening/closing device according to claim 1, wherein the alignment mechanism includes a rolling body rotatably provided on one or both of the first half nut piece and the second half nut piece.

3. The half nut opening/closing device according to claim 2, wherein the rolling body comes into contact with one or both of a tooth and a groove of an engagement portion of the tie rod, to lift the tie rod.

4. The half nut opening/closing device according to claim 3, wherein
the rolling body includes a first rolling body and a second rolling body that is coaxially provided with the first rolling body and is larger in diameter than the first rolling body, and
the first rolling body comes into contact with the tooth of the engagement portion, and the second rolling body comes into contact with the groove of the engagement portion.

5. The half nut opening/closing device according to claim 2, wherein the rotating body is provided in each of the first half nut piece and the second half nut piece, and the rotating bodies are point-symmetrically disposed.

6. The half nut opening/closing device according to claim 1, wherein the alignment mechanism includes a link mechanism that is vertically moved along with opening/closing operation of the first half nut piece and the second half nut piece, and a support body that is supported by the link mechanism and lifts the tie rod.

7. The half nut opening/closing device according to claim 6, wherein the link mechanism includes a first link plate and a second link plate that each include one end swingably fixed to the first half nut piece and another end swingably fixed to the support body, and a third link plate that includes one end swingably fixed to the second half nut piece and another end swingably fixed to the support body.
